(19) United States
(12) Patent Application Publication
(10) Pub. No.: US 2003/0098785 A1
(43) Pub. Date: May 29, 2003

(54) Vehicle back-up alarm sensor for electrical trailer contact

(76) Inventor: Hugh Bishop, Bedford, NH (US)

Correspondence Address: NIXON & VANDERHYE, PC, 1100 N GLEBE ROAD, 8TH FLOOR, ARLINGTON, VA, 22201-4714, US

(21) Appl. No.: 09/994,924

(22) Filed: Nov. 28, 2001

(51) Int. Cl. G08B 21/00

(52) U.S. Cl. 340/431; 340/456

(57) ABSTRACT

A back-up alarm for a motorized vehicle is disclosed comprising: a sounder having an audible emitter activated by an electrical signal input, and an electrical contact coupled to the input of the sounder and having electrical contacts to connect with a preexisting electrical socket to a trailer hitch mounted on a motorized vehicle.

### FIELD OF THE INVENTION

The present invention generally relates to a vehicle back-up alarm.

### BACKGROUND OF THE INVENTION

Back-up audio alarms are well known for use on vehicles. These alarms generally emit an audible series of repeated “beeps”, while a vehicle is in back-up mode. The alarm alerts persons standing behind the vehicle, who may be unaware that the vehicle is approaching them. Drivers of vehicles moving in reverse generally have difficulty in seeing persons standing behind their vehicle. Drives sometimes unknowingly and accidentally back-up towards a person standing behind their vehicle. Back-up alarms have been helpful in avoiding accidents and preventing injuries to people.

Prior back-up alarms have been relatively difficult to install in vehicles. The alarms generally require a mechanic or a person with mechanical aptitude to install into vehicles. In addition, the back-up alarms tend to be relatively expensive. Ordinary vehicle owners often do not install back-up alarms on their vehicle due to the complexity of installation and the time required to install a conventional alarm. Accordingly, back-up audible alarms are not generally used for personal vehicles. Rather, they tend to be used on commercial and government vehicles such as large trucks, school buses and construction equipment.

### BRIEF SUMMARY OF THE INVENTION

There is a long-felt need for an easy-to-install and inexpensive backup audio alarm for vehicles. Preferably, the back-up audio alarm should be inexpensive and quickly installed by an ordinary vehicle owner. To ease the installation process, the back-up alarm electrical system should not require that the vehicle's electrical wiring be modified to connect to the back-up alarm. In addition, preferably the installation of the audio alarm should not require mechanical mounts to be attached to the vehicle that would harm the vehicle body or detract from the visual appearance of the vehicle body.

In one embodiment the invention is a back-up alarm comprising: a sounder having an audible emitter activated by an electrical signal input, and an electrical contact coupled to the input of the sounder and having electrical contacts to connect with a preexisting electrical connector to a trailer hitch mounted on a motorized vehicle.

### BRIEF DESCRIPTION OF THE DRAWINGS

FIG. 1 is a side view of an audible back-up alarm sensor;

FIG. 2 is a side view of the alarm sensor shown in FIG. 1 wherein the sensor housing has been opened to show internal components and the electrical connector component has been separated for illustrative purposes;

FIG. 3 is a plan view of a standard electrical trailer connector, and

FIG. 4 is an enlarged view of a portion of a rear of a vehicle having a trailer hitch with a trailer hitch electrical connector wherein an alarm plug has been inserted in the electrical connector.

### DETAILED DESCRIPTION OF THE INVENTION

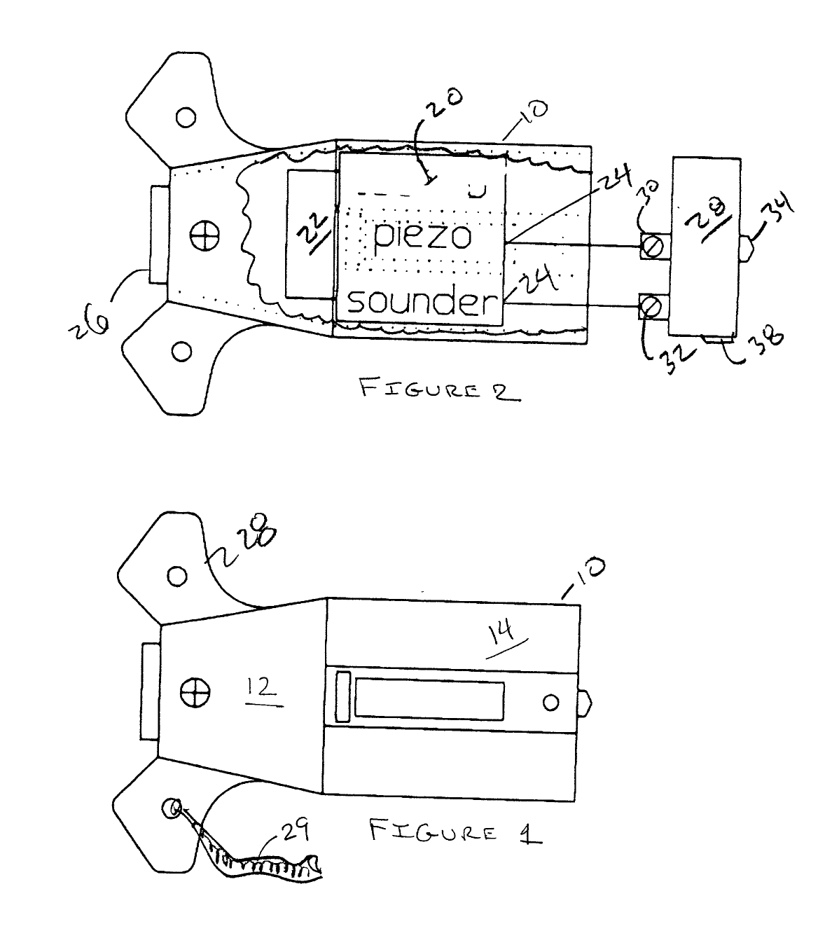

FIG. 1 is a side view of an exemplary alarm sensor plug 10. The plug 10 includes an outer hollow housing having a tapered nose 12 and a cylindrical plug section 14. The plug housing may be formed from the housing of a conventional electrical plug for a trailer receiver. The plug section 14 fits into a standard trailer hitch electrical socket 16 (see FIG. 13). The sensor plug is lightweight and can be fully mounted by installing it into the electrical trailer hitch socket 16 on a vehicle 18 having a trailer hitch or receptacle 17 for a trailer hitch (see FIG. 4). Insertion of the sensor plug 10 into the electrical trailer hitch socket 16 completes the installation of the alarm plug. No further mounting operations or electrical contact operation is needed to install the alarm plug on the vehicle. Once inserted into the hitch receptacle 16, the alarm sensor plug 10 is ready to be used and will emit an audio alarm while the vehicle transmission is in reverse gear.

As shown in FIG. 2, the sensor 10 has an internal piezo-sounder device 20, including a speaker 22 that emits an audible alarm. The sounder is activate to emit the alarm when power is applied to the electrical contacts 24 of the sounder. The piezo-sounder is a commercially available, relatively-small and lightweight piezo-electric device that may be programmed emit a series of audible “beeps” when power is applied to the sounder's electrical contact 24. The piezo-sounder is mounted in the body of the alarm sensor, such that it is protected from rain and other environmental elements.

The audible beeps emitted by the sounder 20 are projected rearward of the sensor 10 and of the vehicle. These nose 12 of the housing is relatively transparent to audio signals. For example, a thin plastic housing may be used to form the nose 12. In addition, a front circular surface 26 of the nose may be an open mesh covered by a web material to allow audio signals to broadcast rearward of the vehicle and to minimize the attenuation of the signal by the housing of the sensor.

The nose 12 of the body may have winglets 28. The winglets provide a finger grip to assist in the insertion and removal of the plug into the electrical socket.

The audio alarm 10 includes an electrical connector 28 mounted in the body of the alarm. The electrical connector includes an electrical contact 30 which provides a conduit for electrical power to the power connector 24 of the piezo-sounder 20. The electrical connector may also include an electrical ground connection 32 that provides an electrical contact for a ground connection 34 of the sounder. The electrical connector 28 of the audio alarm fits into the electrical contact of the trailer electrical socket receptacle 16.

The connector 28 has a power connector 34 that electrically connects to a power terminal 36 at the center of the electrical receptacle 16 of the trailer hitch. Similarly, the electrical connector 28 has a ground connector 38 that provides an electrical ground coupling between the sounder and a ground connector 40 on the trailer electrical receptacle 16. The arrangement of power connector and ground connector (or other electrical connections) on the connector 28 of the alarm system is designed to match a standard electrical trailer hitch receptacle 16.

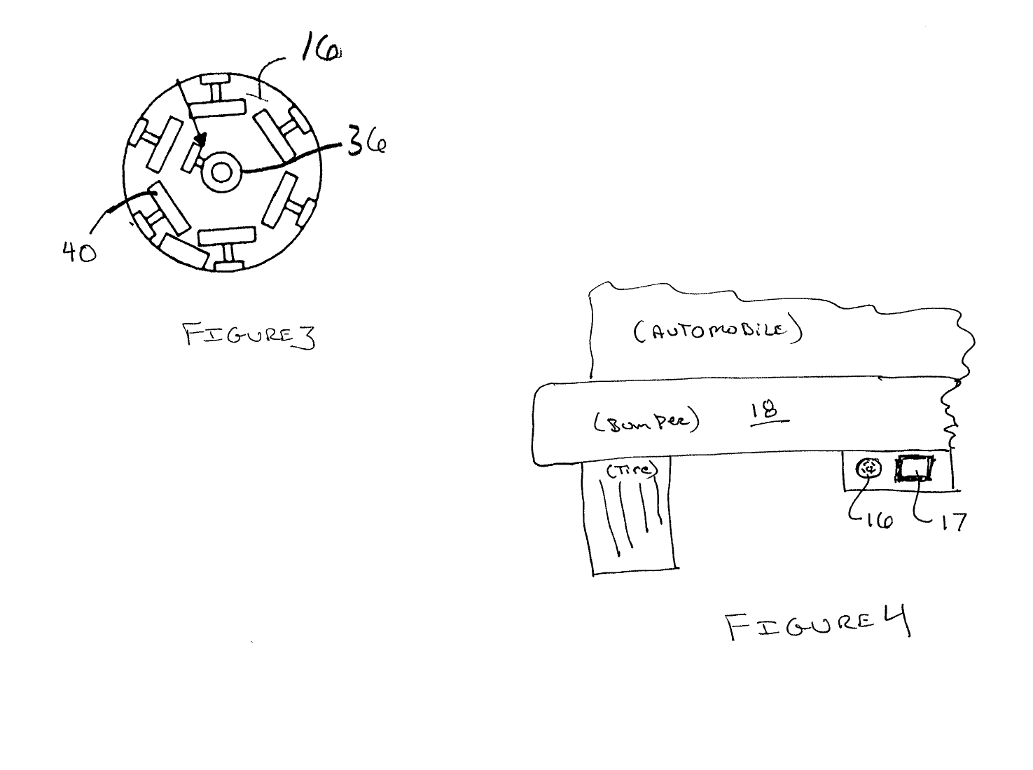

The seven-blade electrical connector 16 shown in FIG. 3 is one example of a standard electrical connector typically used with recreational vehicle (RV) vehicles in the United States. There are other types of trailer hitch electrical connectors that are commonly used in the United States and other countries. The electrical connector 28 of the alarm sensor may be designed to couple to other types of standard electrical trailer hitch connectors. The connector 28 may be designed to fit any one or more of the standard electrical connectors typically used with trailer hitches for motorized vehicles. These standard electrical connectors may include form standard electrical connectors on older vehicles, current standard electrical connectors such as the seven-blade connector, and future electrical standards developed for installation at the rear of vehicles.

As shown in FIG. 4, an electrical trailer hitch receptacle 16 is generally mounted on the rear of the vehicle and faces rearward of that vehicle. By inserting the alarm plug 10 into the electrical receptor 16, the plug also faces rearwardly of the vehicle. The insertion of the alarm plug into the electrical connector provides electrical power to the piezo-sounder by virtue of the connection of the power connector 34 and 36 on the plug and trailer electrical connector, respectively. Moreover, the sensor plug 10 is lightweight and small, such that the insertion of the sensor into the electrical socket receptacle 16 provides sufficient structural support to hold the alarm plug 10 onto the vehicle. A latch may be incorporated into the body of the sensor plug 10 to ensure that the plug does not inadvertently slide out of the trailer hitch electrical receptacle and to prevent theft of the plug when installed in the receptacle.

In operation, the power connector 36 on the trailer hitch receptacle 16 is active, e.g., has 12-volt electrical power applied, only when the vehicle is in back-up mode. For example, when the driver of the vehicle moves the transmission of the vehicle into a reverse gear, the vehicle electrical system automatically applies power to the reverse power connection 36 of the trailer hitch electrical connector. In conventional practice, the reverse power connection 36 provides electrical power for back-up lights on a trailer hitched to the vehicle. However, in this application, the reverse power coupling is used to provide power to the sounder 20, of the alarm plug 10 which is only applied when there is no attached trailer. When power is applied to the sounder at connection 24, the sounder automatically generates and emits an audible alarm through speaker 22. The audible alarm may be a series of high-pitched beeps that provide an audible warning to anyone standing behind the vehicle that the vehicle is backing up. When the vehicle is no longer in back-up mode, power is terminated to the power coupling 36 and the sounder stops emitting an audible signal because it is no longer being powered at terminal 24. Accordingly, the alarm plug 10 emits an audible back-up alarm when the vehicle is in back-up mode, thereby causing power to be applied to the reverse alarm plug.

The alarm plug 10 may be easily removed by being pulled out of the electrical receptor 16. A lanyard 29 may be tied to the winglet 28 of the alarm body and also tied to the trailer hitch such that the alarm body may remain attached even when disconnected from the electrical socket 16. The lanyard may include a lock to secure the alarm plug to the vehicle. The alarm sensor may be removed from the electrical socket 16 to allow a trailer to be mounted to the vehicle and the electrical connection plugged into the trailer hitch electrical socket 16 instead of the alarm sensor. While the back-up alarm is not available for use while a trailer hitch electrical connector is mounted in the electrical socket 16, the instances in which a trailer is mounted on many vehicles is infrequent. Accordingly, it would be a relatively-rare instance in which the back-up alarm 10 would be removed from the electrical socket 16. Thus, the alarm sensor 10 may be mounted in the electrical receptacle 16 of the trailer hitch during most vehicle operations. Moreover, the alarm sensor 10 may be intended for use on vehicles which routinely do not have trailers attached, and thus generally have an open trailer electrical socket 16.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim:

1. A back-up alarm comprising:
a sounder having an audible emitter activated by an electrical signal input, and
an electrical contact coupled to the input of the sounder and having electrical contacts to connect to a preexisting electrical socket for a trailer hitch mounted on a motorized vehicle.

2. A back-up alarm as in claim 1 wherein the electrical socket is a standard seven-blade electrical socket for a trailer hitch.

3. A back-up alarm as in claim 1 further comprising an alarm plug body housing the sounder and having, at one end of the body, electrical contacts for coupling to the preexisting electrical socket.

4. A back-up alarm as in claim 3 wherein the body housing includes a cylindrical section housing the electrical contacts and a nose section facing reward of the vehicle.

5. A back-up alarm as in claim 1 wherein the sounder is powered by a back-up light power line of a vehicle electrical system.

6. A back-up alarm as in claim 1 wherein the sounder includes a piezo-sounder and a speaker.

7. A method for installing a back-up alarm device onto a vehicle comprising the steps of:
a. inserting the back-up alarm device into an electrical socket of a trailer hitch on the rear of the vehicle;
b. connecting an electrical power coupling for the alarm to a back-up light power connection in the electrical socket as the back-up alarm is inserted into the connector, and
c. mechanically supporting the back-up alarm device on the vehicle by the installation of the device in the electrical socket.

8. A method as in claim 7 wherein the back-up light power connection provides power to a sounder in the back-up alarm device when the vehicle is in back-up mode.

9. A method as in claim 7 wherein the back-up light power connection provides power to a piezo-sounder in the back-up alarm device.

10. A method as in claim 7 further comprising the step of removing the back-up alarm device from the vehicle by removing the device from the electrical socket.
